(19) United States
(12) Patent Application Publication
(10) Pub. No.: US 2014/0344159 A1
(43) Pub. Date: Nov. 20, 2014

(54) License Key Generation

(71) Applicant: Dell Products, LP, Round Rock, TX (US)

(72) Inventors: Marshal F. Savage, Austin, TX (US); Neelakandan Nagarajan, Round Rock, TX (US); Travis J. Cain, Austin, TX (US)

(73) Assignee: Dell Products, LP, Round Rock, TX (US)

(21) Appl. No.: 13/897,536

(22) Filed: May 20, 2013

(51) Int. Cl. G06Q 99/00

(52) U.S. Cl. CPC G06Q 99/00
USPC 705/59

(57) ABSTRACT

An information handling system includes a product fulfillment system and a license generation system. The product fulfillment system processes orders for products, including maintaining product data and order data device. The license generation system receives product data and order data about orders for products from the product fulfillment system. It also generates license keys for the products. The generating includes executing software programs using as input values received from the product fulfillment system.

### FIELD OF THE DISCLOSURE

This disclosure generally relates to information handling systems, and more particularly relates to a system and method for license key generation.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems. A seller or maker of an information handling system may bind the information handling system or a hardware or software component of the system to a license key to prevent an unauthorized user from using the information handling system or the component without a license.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a system to generate a license key for an information handling system according to an embodiment of the present disclosure;

FIG. 2A is a block diagram of a factory to generate a license key for an information handling system according to an embodiment of the present disclosure;

FIG. 2B is a block diagram of a fulfillment system to generate a license key for an information handling system according to an embodiment of the present disclosure;

FIG. 3 is a flow diagram of a method for generating a license key for an information handling system according to an embodiment of the present disclosure;

FIG. 4 is a flow diagram of a method for generating a license key for an information handling system according to another embodiment of the present disclosure;

FIGS. 5 and 6 are a flow diagram of a method for generating a license key for an information handling system according to another embodiment of the present disclosure; and

FIG. 7 is a block diagram of a general information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application.

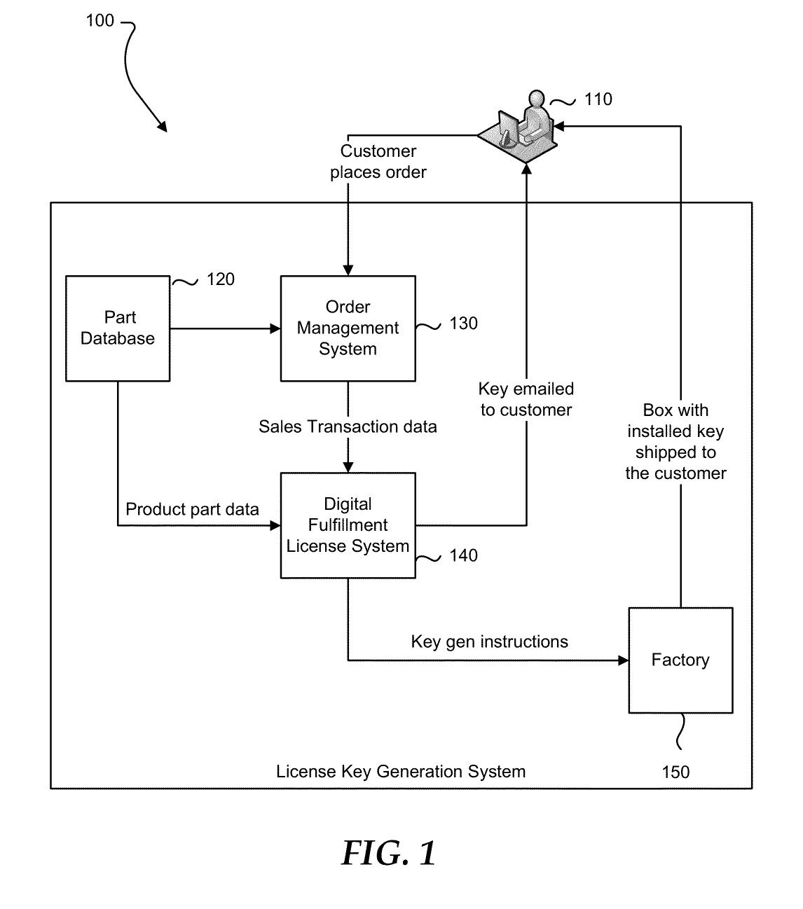

FIG. 1 illustrates a block diagram of a license key generation system 100 to generate license keys for an information handling system. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

License key generation system 100 includes a part database 120, an order management system 130, a digital fulfillment license system 140, and a factory 150. Part database 120 may maintain information about products for sale by a company in the form of a database. Entries listed with a product may include a description, a price, and a unique identifier of the part, such as a stock-keeping unit (SKU). Entries may describe features or aspects of a product, such as levels of functionality. For some products, over 100 features may be available. Products may include physical products, software, and virtual products, such as feature enablement. Examples include the number of virtual machines that may operate on physical machines, and a level or set of features on a remote management controller. These sets of features will be referred to as quantities of features. Part database 120 may provide information about products to order management system 130 and to digital fulfillment license system 140. The product part data may consist of meta information that defines what a product is and how it should be fulfilled.

Order management system 130 may parse orders received from customers, such as from customer 110. The parsing may include extracting the separate products from an order, and determining the number of each separate product in the order. The products may include physical products, software, and virtual products. Order management system 130 may also combine separate products when the combination is covered by a single license. As an example, a seller may produce a systems management application (software) that enables a customer to monitor its infrastructure. The seller may charge $50 per physical device (server, switch, printer, storage . . . ) to monitor and $10 per virtual device (virtual Machine, virtual switch . . . ) as license fee for the product. The customer has 5 servers, 1 switch, 1 printer and 25 virtual machines running on the 5 servers. Based on that setup, the sales team may create a quote to cover support for 7 physical machines and 25 virtual machines. Order management system 130 may parse the quote to determine that a single license key for 7 physical machines and 25 virtual machines could cover the physical machines and virtual machines of the order. As the customer grows, it could add more physical or virtual devices to be managed independently. As another example, a product may be available with regular features or advanced features. A customer may purchase 20 of the product with regular features and 5 of the product with advanced features. Order management system 130 may parse a quote for the purchase to determine that a single license key for 10 of the product with regular features and 5 of the product with advanced features could cover the purchase of the 15 copies of the product with the two levels of features. Order management system 130 passes the parsed sales transaction data, including data describing the license keys to be generated, to digital fulfillment license system 140.

Digital fulfillment license system 140 may assemble all or a portion of the data used to create a license. It may also have access to code that generates a license key from input. When digital fulfillment license system 140 has all of the necessary information, it may run the license key generation code on the data and forward the license key to the customer. It may, for example, email the license key to a customer, such as customer 110, when the customer has ordered a product that can be downloaded over a network such as the Internet.

When digital fulfillment license system 140 lacks some of the information necessary to generate license key, it may forward the information it assembled and instructions on what other information is needed to another unit to complete the generation. In FIG. 1, for example, it may forward the information to factory 150. Physical manufacturing and assembly of a product may take place at factory 150. During the process, factory 150 may generate data used in license key generation, such as a serial number of a product. Factory 150 may add the data it generates to the data supplied by digital fulfillment license system 140 and follow the instructions provided to generate a license key for a product. Factory 150 may then supply the license key to the customer, such as customer 110. Factory 150 may, for example, install the license key in nonvolatile ram on the product and then ship the product to the customer in a box.

Embodiments of FIG. 1 may enable the integration of license key generation system and a product fulfillment system. When a company creates a new product, it may determine what information will be available from its fulfillment system about the product and the terms of the order, determine an algorithm for generating keys for the product that uses the available information, and transmit the data from the product fulfillment system to the license key generation system so that it may automatically generate the keys with the data supplied by the product fulfillment system.

Similarly, embodiments of FIG. 1 may enable a company to integrate the license key generation of a newly-acquired product into its own license key generation system. The company may obtain the code used to generate license keys for the product and information about the inputs to the code. The company may then locate the information in its product fulfillment system. In the course of fulfilling orders for the product, the product fulfillment system may supply the license key generation system with the information used as inputs and the license key generation system may run the license key generation software on the inputs to product license key for the newly-acquired product. In some cases, if the desired input is not part of the fulfillment system, the company may simply substitute a constant or redefine the input. In other cases, the company may further modify its fulfillment system to incorporate the data needed for the license key generation.

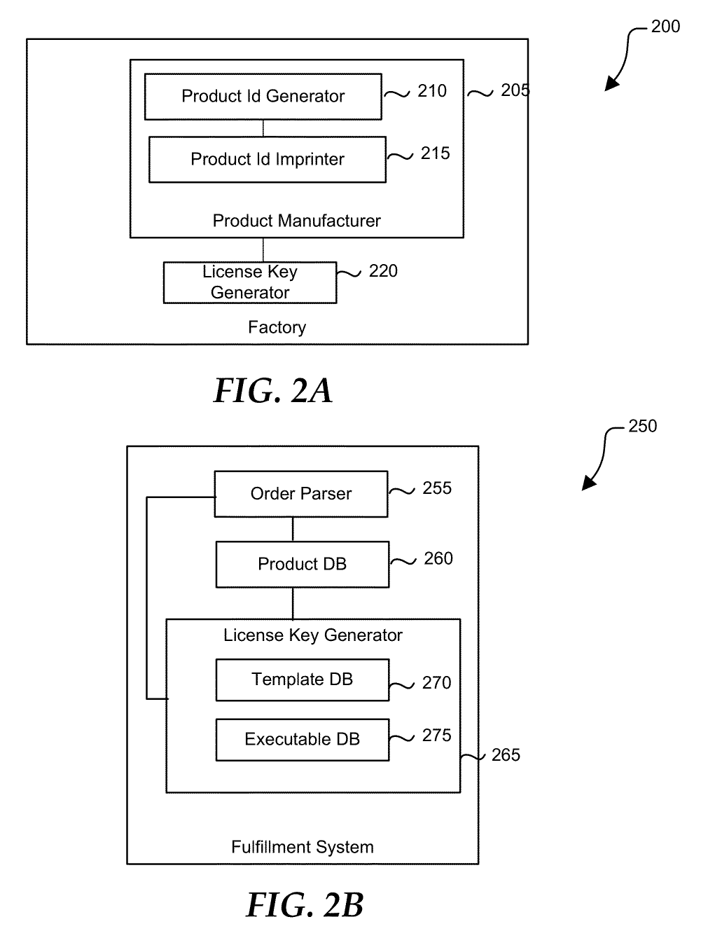

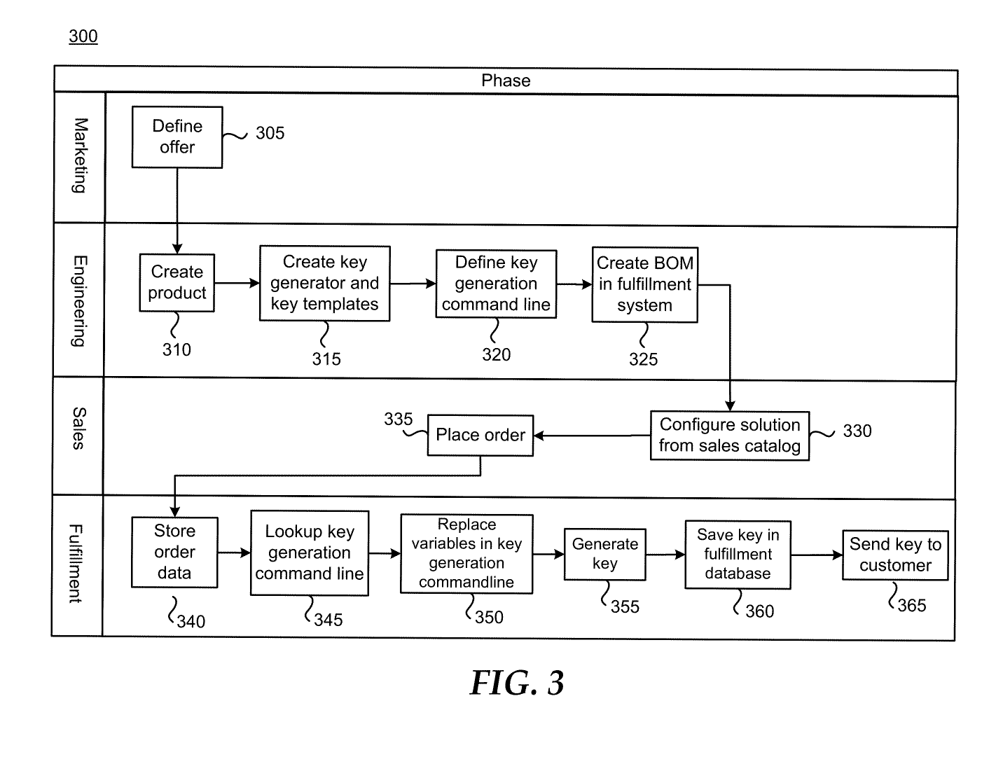

FIG. 2A illustrates a factory 200 that generates a license key. Factory 200 includes product manufacturer 205 and license key generator 220. Product manufacturer 205 may manufacture products and may include assembly lines and raw materials inputs. Product manufacturer 205 includes product identification generator 210 and product identification imprinter 215. Product identification generator 210 may generate data about a product, such as a serial number or other unique identifier of the product. Product identification imprinter 215 may generate documentation containing the serial number or other unique identifier to the product. The documentation may be shipped to the customer with the product or separately. In some cases, the identification is stamped or otherwise engraved onto the product itself.

License key generator 220 may generate license keys for products made or produced at factory 200. License key generator 220 may have access to code that produces license keys. License key generator 220 may obtain some of the inputs from a fulfillment system and may obtain the remaining inputs from product manufacturer 205, which may generate the inputs in the course of manufacturing, producing, or assembling products. License key may execute the code on the combined inputs to produce license keys and may supply the license keys to customers. It may also supply the license keys or the data used to produce them to the fulfillment system. The fulfillment system may then be able to regenerate the license keys if necessary.

In some embodiments, a factory may generate license keys for some products and other divisions of a business may generate other license keys. In other embodiments, a factory may generate all of the license keys. In yet other embodiments, other divisions may generate all of the keys. A factory that creates data used in license key generation may send the data to other divisions for creation of license keys. The license keys may then be sent to the customers.

FIG. 2B illustrates a fulfillment system 250 to fulfill customer orders. It includes order parser 255, product database 260, and license key generator 265. Order parser 255 may parse customer orders to determine the products ordered, including product specifications and amounts. Order parser 255 may, for example, determine the features covered by a particular license, as well as the number of virtual or physical machines that the license may operate upon. Order parser 255 may access product data base 260 in order to determine information about products described in an order. In some embodiments, order parser 255 may group products so that a single license key may cover the group, as in the example described above, in which a license covered multiple physical and virtual machines. Order parser 255 may pass the results of its parsing to license key generator 265.

License key generator 265 may generate license keys for customer orders. License key generator 265 includes template data base 270 and executable database 275. Template data base 270 may contain templates that describe the information needed to generate license keys, including information about the process of license key generation and sources of data used as input to code to generate license keys. In some embodiments, the information includes variables that designate parameters available to fulfillment system 250, such as SKUs of products or the number of virtual machines included in an order. The information may also include the name of an executable file that creates license keys for particular products and a file name to store a license key once generated.

Table 1, below, is an example template in Extensible Markup Language (xml) format. Lines 8-12 contain instructions for naming an output file containing the generated license key. The file name is obtained by concatenating a service tag, a binding ID, and the string “License.” In Table 1, objects enclosed in braces ({ }) designate variables. Lines 16-31 describe parameters available to a fulfillment system that may be used to generate a license key. The parameters may include a reference ID, a sale date, start date, end date, service tag, duration, template file, license dimension identifier, device identification, and product offer description. Dimensions are lists of numbers representing quantities of features of a product that will be enabled. A dimension may, for example, measure seats—the number of users permitted to use a product, the number of virtual machines that may be running, or some other quantity of a product. In the example of licenses for 25 virtual machines running on 7 physical machines, the dimension entry may consist of a list of two elements which indicate the numbers 7 and 25. Other information may indicate which aspects of the license the numbers apply to.

Lines 33-45 of the example template of Table 1 represent information about executing code to produce license keys. Lines 41 and 45 contain the names of executable files which may produce license keys. Line 41 names a code version for Windows 64 and line 45 names a version for Windows 32. Lines 33 through 37 indicate the format for calling the executable to generate the license key and show the calling parameters that may be used.

```
TABLE 1
  1  <?xml version=″1.0″ encoding=″utf-8″?>
  2  <AdditionalAttributes>
  3  <Header>
  4  <MessageType>AdditionalAttributes</MessageType>
  5  <MessageRevisionNumber></MessageRevisionNumber>
  6  </Header>
  7  <Generate>
  8  <!-- Possible values for LicenseFileName are {Service Tag}
  9  | {RefID} | {BindingID} | String -->
10  <Attribute Name=″LicenseFileName″ Value=″{Service Tag}-
11  {BindingID}-License″/> <!--Output should be like DFJJ123-
12  abczzz-License.lic-->
13  <!-- Possible values for LicenseFileFormat are dat | xml|
14  lic -->
15  <Attribute Name=″LicenseFileFormat″ Value=″lic″/>
16  <!-- Possible Keygen parameters
17  ∘  {RefID} (string) Unique ID for every generated key
18  ∘  {UTCSoldDate} (string,  purchase date UTC format)
19  ″2011-12-05T16:03:15Z″
20  ∘  {StartDate} (string,  purchase date UTC format) “2011-
21  12-05T16:03:15Z”
22  ∘  {EndDate} (string,  purchase date UTC format) “2011-12-
23  05T16:03:15Z”
24  ∘  {SERVICE_TAG} (string)
25  ∘  {TemplateFile}  (Static file based on SKU sold, contains
26  offer specific information)
27  ∘  {<License Dimension Identifier>} (long long - Possible
28  values are defined in SKU configuration (part data database)
29  tool
30  ∘  {DeviceID} (string)
31  ∘  {Product Offer Description}
32  -->
33  <Attribute Name=″COMMANDLINE″ Value=″{KeyGenFileName} -
34  DeviceID= {DeviceID} -TemplateFile={TemplateFile} -
35  UTCSoldDate={UTCSoldDate} -StartDate={StartDate} -
36  EntitlementID={EntitlementID} -ServiceTag={SERVICE_TAG} -
37  EndDate={EndDate} -Sockets={Dimension1}″ />
38  <OSList>
39  <OS Name = ‘Windows’ Architecture = ‘64’>
40  <Attribute Name =″KeyGenFileName″
41  Value=″KeyGenerator_x64.exe″/>
42  </OS>
43  <OS Name = ‘Windows’ Architecture = ‘32’>
44  <Attribute Name =″KeyGenFileName″
45  Value=″KeyGenerator_x32.exe″/>
46  </OS>
47  </OSList>
48  </Generate>
49  <Install>
50  <Attributes>
51  <Attribute Name=″InstallType″ Value=″Folder″/> <!--
52  Possible values: Folder or NVRAM-->
53  <Attribute Name=″ExtendedInstallInformation″ Value =
54  ″c:\licensekeyfolder\″ />
55  </Attributes>
56  </Install>
57  </AdditionalAttributes>
58
```

Executable database 275 contains code that can generate license keys when the code is supplied the necessary information as inputs. The code in executable database 275 may consist of executable files in an operating system, such as .exe files in Windows. In some embodiments, the code may be called with a command line command and the input may be supplied as parameters to the command line.

License key generator 265 may receive information about the licenses needed for an order, such as the order parsing information from order parser 255. For each license, it may determine a template from template data base 270 that describes the information needed to generate the license key. It may then select an executable from executable database 275 and run the executable on the appropriate information to generate the key. In many cases, the information may be made available as a mapping between variables in the templates and parameters maintained by fulfillment system 250. As an example, the variables in lines 12-29 of TABLE 1 may refer to parameters maintained by fulfillment system 250 in the course of processing orders for products. When one of the variables is used in a template to produce a license key for a product, the value of the parameter may be substituted for the variable in executing the code associated with the template. As a result, the generation of license keys may be integrated with a product fulfillment system. In some embodiments, the code in executable database 275 may be developed on the basis of the maintained parameters. The code may be designed so that its input values may be obtained from fulfillment system 250. Accordingly, the writing of the code will not require the creation of special purpose routines to obtain data about orders to be incorporated in license keys.

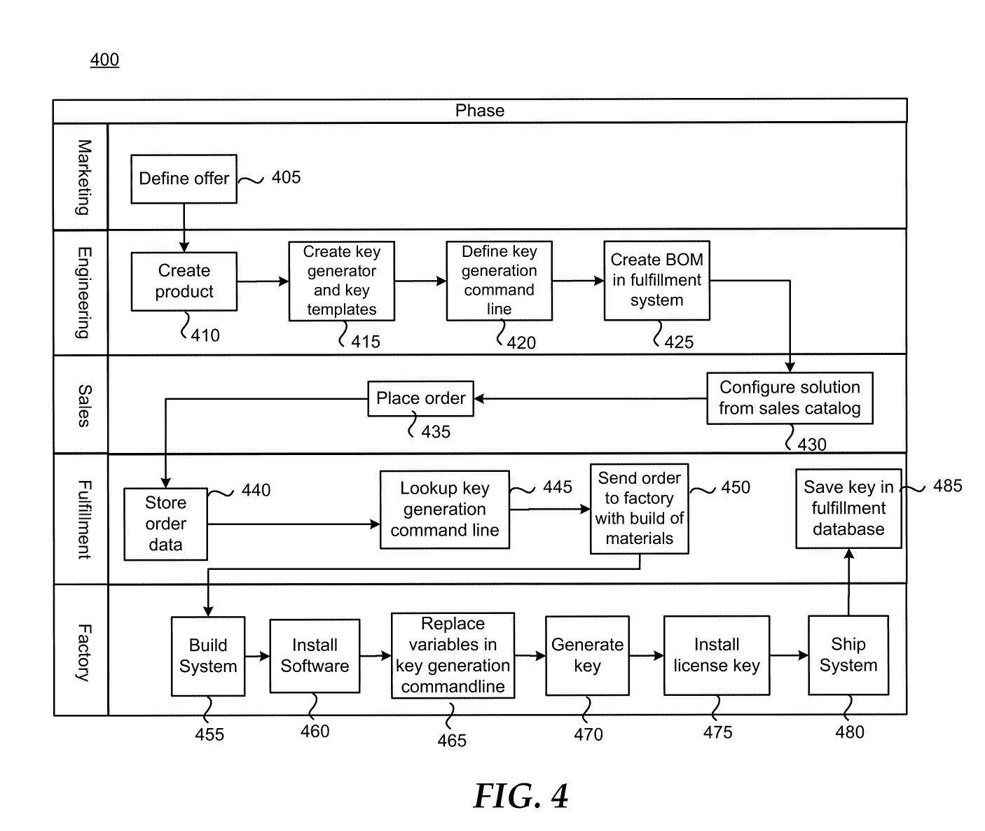

FIG. 3 illustrates a method 300 for generating license keys for products, including physical equipment, software, and virtual products. The method may be performed by a business. Tabs at the left indicate divisions of the business that may perform the particular steps of the method. The divisions include marketing, engineering, sales, and fulfillment. At block 305, a marketing representative of a seller may define an offer. An offer is a unique configuration of a product that may be purchased for a given price by a customer. An offer may represent a specific embodiment of a product that is described in a catalog and may be selected by a customer. The description may include features of a product. A company may, for example, offer different versions of a software program with different features or may offer different models of a general physical machine. In addition, the offer may include terms of sale.

At block 310, the business may create the product. The creation may involve writing software or designing and manufacturing hardware. At block 315, the business may create a license key generator and license key templates. The license key generator may consist of code whose execution creates a license key for the product. In many embodiments, the code may be designed so that the inputs required by the code are generated during the product fulfillment process; that is, the data consists of information about an order such as a product and features.

The template may contain information about the inputs to the license key generator. In some embodiments, it may also provide bookkeeping information about the process of generating the license key, such as the name of an executable file holding the code to generate the license key and the name of an output file to hold the generated license key. In some embodiments, the template may contain data similar to the template in TABLE 1. In further embodiments, the template may contain variables whose values are to be filled by information generated during the process of product fulfillment.

At block 320, the business may define a license key generation command line. The line may be a command in a command line interface. In such an interface, a program may be called by commands in the form of lines of text. In some embodiments, code to carry out a fulfillment system of the business may have a command line interface, and license key generation may be one of the functions of the fulfillment system. The definition of the command line may describe the actual call, which may be the name of the executable file, and parameters of the call. Lines 31-34 of TABLE 1 provide an example definition of a license key generation command line.

At block 325, the business may create a build of materials (BOM) in a business fulfillment system. This may be a list of inputs, including components and raw materials, used to assemble a finished product. In the embodiment of FIG. 3, blocks 310 through 325 may be performed by the engineering department of the business.

At block 330, the business may configure a solution from a sales catalog. A sales representation may discuss a customer's business needs with the customer and may make suggestions based upon the business's product offerings. The solution may involve hardware and software. At block 335, the business may place an order. In the embodiment of FIG. 3, blocks 330 and 335 may be performed by a sales department.

At block 340, the order may be stored, such as through entry into the business fulfillment system. At block 345, the business fulfillment system may look up the command line used to generate a license key for the product or products covered by the order. At block 350, the variables in the command line are replaced by data from the sale, including order data and data about the product or products that may be available from a product database. In some embodiments, for example, the command line variables may refer to values generated during product fulfillment. The replacement of the variables with values is then carried out by finding the fulfillment system values referenced by the variables and substituting those values for the variables.

At block 355, the license key is generated. The license key may be generated by executing the command line command used for generating the key. At block 360, the license key is saved in the fulfillment database. The license key may be needed in the future if, for example, the customer loses the key. At block 365, the license key is sent to the customer. Delivery may depend upon the method for delivery of the product. If the customer downloads the product, the license key may be sent by email or downloaded over a network. If the product is shipped to the customer, the license key may be included in the shipment. It may be contained in documentation or included with the product. In the embodiment of FIG. 3, blocks 340 through 365 may be performed by the fulfillment department of a business.

In other embodiments, a license key may be generated without a business performing all of the blocks of FIG. 3. A business may, for example, acquire a product from another business. It may, for example, purchase the rights to the product or may acquire the other business. The previous owner may have already produced code to generate license keys for the product. Accordingly, it may be unnecessary for the purchasing business to write code to generate keys for the product. Instead, the business may attempt to match the inputs to the code to parameters available through the business fulfillment system. If all of the inputs are available, the business may create a command line with variables that refer to the parameters. In further embodiments, the command line may be represented in a template that describes the values used to produce a license key for the product. When an order for the product is placed, the variables will be replaced by the actual values of the order and the code called with those values. If some of the inputs are not available in the fulfillment system, the business may revise its fulfillment system to obtain the missing inputs, or may substitute constant values or other values for the missing values and call the license key generation code with those substitute values. In some embodiments, an order parser may operate to examine orders and determine a product or products described in orders for which to generate license keys. The templates may be indexed by product and by other order information.

As a result, the integration of license key generation for the product into the purchasing business may be simplified. Without a process such as described in FIG. 3, the integration of new products into a business whether the products are purchased from a third party or acquired through mergers and acquisitions may requires extensive development efforts to integrate new product license key generators into the business infrastructure. In some cases, the process may take months to years to complete and may cost thousands of dollars in human resources. The process may also cause significant delays with the integration of acquisitions when new products cannot be brought to market in a timely manner. The problems exist because there is no industry standard that defines how license keys should be created and how solutions should enable/disable functionality based on the license key. Under the method of FIG. 3, however, the integration of a new product may be simplified. Instead of rewriting code to generate the license key for the product and writing code to obtain needed input values for the code from the company's data systems, it is enough to generate a template that identifies the values as found in the company's fulfillment system, including a database of products and data from orders.

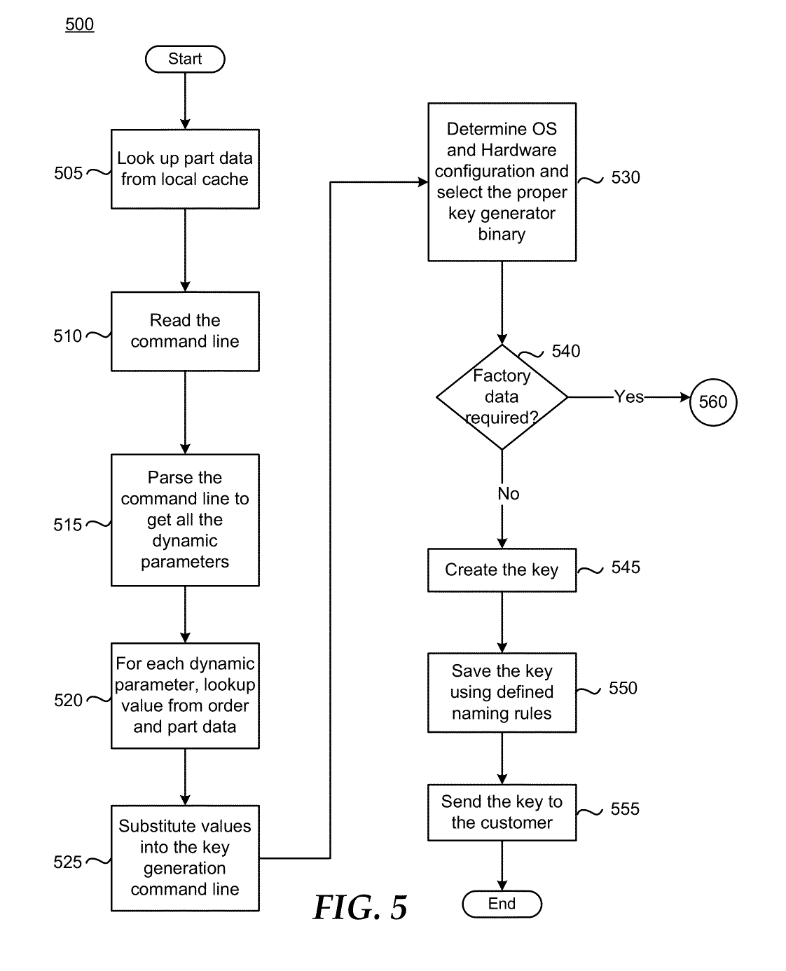

FIG. 4 illustrates another method 400 for generating license keys for products, including physical equipment, software, and virtual products. The method may be performed by a business. Tabs at the left indicate divisions of the business that may perform the particular steps of the method. The divisions include marketing, engineering, sales, fulfillment, and factory. In some embodiments, the factory may be an original design manufacturer, an independent company that designs product to be issued under the brand of another company.

Method 400 is similar to method 300 of FIG. 3, except that method 400 includes blocks performed at the factory. Thus, blocks 405, 410, 415, 420, 425, 430, 435, 440, and 445 of FIG. 4 may be similar to blocks 305, 310, 315, 320, 325, 330, 335, 340, and 345 of FIG. 3. At block 450, the fulfillment system sends the order to the factory with the build of materials for the order. Included with the order may be information about license key generation, such as the command line for license key generation, the list of variables that is input to the license key generation code, and values for the variables that were available to the fulfillment system.

At block 455, the factory builds the system. The process may include generating identifiers and other data about the system, such as a serial number or media access control (MAC) address. At block 460, software for the system is installed. At block 465, variables in the license key generation command line are replaced by the actual values. Some of the values may have been created during the manufacturing process, and thus may not have been available before that process. Other values may have been supplied by the fulfillment system. At block 470, the license key is generated by execution of the command line. At block 475, the license key is installed in the system. At block 480, the system is shipped to a customer. At block 485, the license key is saved in the fulfillment system. Thus, if the customer loses the license key or it otherwise needs to be regenerated, it may be regenerated from the fulfillment system of a business. Accordingly, the business does not have to depend on the factory to help with license key regeneration. In some embodiments, the factory may provide the business with the data needed to generate the license key and the business is able to regenerate the license key by calling the license key generation code with the proper input values.

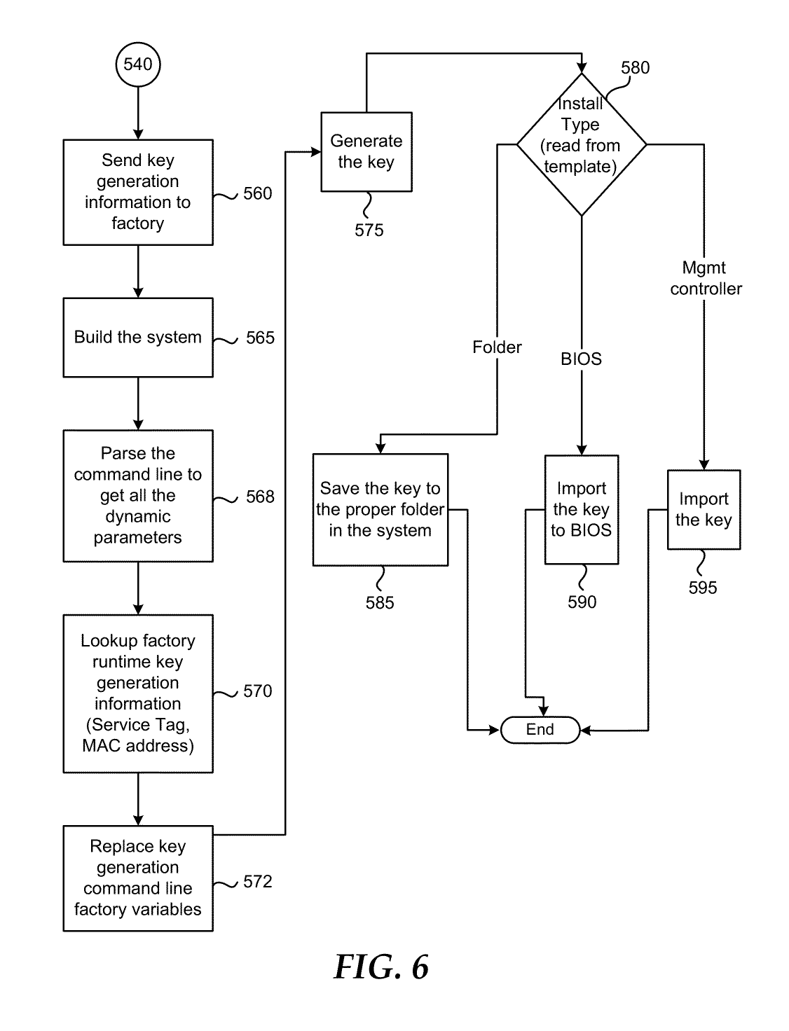

FIGS. 5 and 6 illustrate another method 500 for generating a license key for an information handling system. The information handling system may be a product sold by a company. The company fulfillment system may maintain data about the product and about the order that may be used as input to generate the license key for the product. At block 505, the fulfillment system may look up part data from a part database such as part database 120. At block 510, the fulfillment system may read a command line to generate a license key for the product. Code for generating the license key may be called through a command line interface. In some embodiments, the command line may be indexed by product. In further embodiments, a template is associated with each product for which a license key is to be generated. Included in the template is information about the command line to be composed to generate a license key for the product. In other embodiments, any data structure or data structures that describe the variables used to generate the license key may be used.

At block 515, the command line is parsed to obtain all the dynamic variables. These may be variables whose values are created or otherwise determined during the order fulfillment process. At block 520, for each dynamic variable, the value is looked up from the order and from a part data base. In other embodiments, other sources of information may be utilized to obtain the dynamic values. Some businesses may, for example, maintain a database of customers which can be used to look up dynamic values. At block 525, the looked-up values are substituted for the variables in the command line. At block 530, the proper license key generator binary file is selected based upon the operating system (OS) and hardware configuration. In TABLE 1, for example, lines 35 and 37 contain file names of license key generation files for 32-bit and 64-bit operating systems.

At block 535, all known variables in the command line are replaced. At block 540, it is determined whether factory data is required. If so, flow proceeds to block 560 of FIG. 6. If not, flow proceeds to block 545. With all of the variables replaced by values, the license key is created by calling the code to generate the license key with the input values. At block 550, the license key is saved. In some embodiments, the template associated with the product may describe a file name for saving the license key. At block 555, the license key is sent to the customer.

At block 560, license key generation data is sent to the factory. The data may include the name of an executable file to run to produce the license key, input values to the executable file whose values were obtained in the course of processing the order, and variables representing data to be created at the factory. At block 565, the system ordered by the customer is built. The build may include generating identifiers or other data about the product used in the license key generation process. At block 568, the command line is parsed to obtain the dynamic parameters. At block 570, information generated at the factory that is used in the license key generation process is looked up. This information may include a MAC address or a Service Tag. A Service Tag may be a unique identification attached to a product, such as a serial number. At block 572, the variables in the license key generation command line are replaced by values obtained at the factory, and at block 575 the license key is generated by calling the license key generation code with the proper command line, including the values of the variables. At block 580, the install type, or method by which a license key is made available during installation, is determined. For some products, for example, the user may enter the license key into the system during installation. In these cases, the license key may be emailed or otherwise sent to a user. In other cases, the license key may be embedded in the product, and a particular storage location may be checked during installation. Depending on the installation method, the license key may be placed in the proper location for use during installation. If the system is to check for the license key at a certain location of storage in the product, then at block 585 the license key is saved to the proper folder in the system. In some embodiments, a template that describes the license key generation process may contain naming rules for creation of a file for storing the license key. In some cases, the installation process may check for the license key in BIOS (basic Input/output system). In those cases, the license key may be imported into BIOS at block 590. In a third case, a management controller may check for the license key during the installation process. In this case, the license key may be imported into the system by the management controller at block 595.

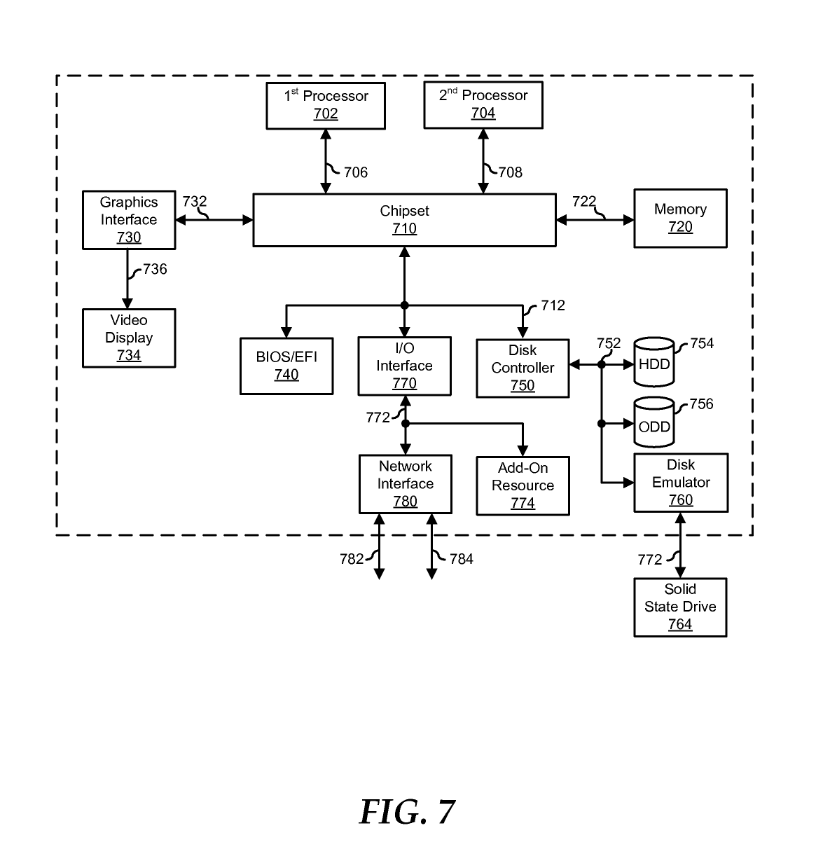

FIG. 7 illustrates a generalized embodiment of information handling system 700. Information handling system 700 can include devices or modules that embody one or more of the devices or modules described above, and operates to perform one or more of the methods described above. Information handling system 700 includes a processors 702 and 704, a chipset 710, a memory 720, a graphics interface 730, include a basic input and output system/extensible firmware interface (BIOS/EFI) module 740, a disk controller 750, a disk emulator 760, an input/output (I/O) interface 770, and a network interface 780. Processor 702 is connected to chipset 710 via processor interface 706, and processor 704 is connected to the chipset via processor interface 708. Memory 720 is connected to chipset 710 via a memory bus 722. Graphics interface 730 is connected to chipset 710 via a graphics interface 732, and provides a video display output 736 to a video display 734. In a particular embodiment, information handling system 700 includes separate memories that are dedicated to each of processors 702 and 704 via separate memory interfaces. An example of memory 720 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 740, disk controller 750, and I/O interface 770 are connected to chipset 710 via an I/O channel 712. An example of I/O channel 712 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 710 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 740 includes BIOS/EFI code operable to detect resources within information handling system 700, to provide drivers for the resources, initialize the resources, and access the resources. BIOS/EFI module 740 includes code that operates to detect resources within information handling system 700, to provide drivers for the resources, to initialize the resources, and to access the resources.

Disk controller 750 includes a disk interface 752 that connects the disc controller to a hard disk drive (HDD) 754, to an optical disk drive (ODD) 756, and to disk emulator 760. An example of disk interface 752 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 760 permits a solid-state drive 764 to be coupled to information handling system 700 via an external interface 762. An example of external interface 762 includes a USB interface, an IEEE 1394 (Firewire) interface, a proprietary interface, or a combination thereof. Alternatively, solid-state drive 764 can be disposed within information handling system 700.

I/O interface 770 includes a peripheral interface 772 that connects the I/O interface to an add-on resource 774 and to network interface 780. Peripheral interface 772 can be the same type of interface as I/O channel 712, or can be a different type of interface. As such, I/O interface 770 extends the capacity of I/O channel 712 when peripheral interface 772 and the I/O channel are of the same type, and the I/O interface translates information from a format suitable to the I/O channel to a format suitable to the peripheral channel 772 when they are of a different type. Add-on resource 774 can include a data storage system, an additional graphics interface, a network interface card (NIC), a sound/video processing card, another add-on resource, or a combination thereof. Add-on resource 774 can be on a main circuit board, on separate circuit board or add-in card disposed within information handling system 700, a device that is external to the information handling system, or a combination thereof.

Network interface 780 represents a NIC disposed within information handling system 700, on a main circuit board of the information handling system, integrated onto another component such as chipset 710, in another suitable location, or a combination thereof. Network interface device 780 includes network channels 782 and 784 that provide interfaces to devices that are external to information handling system 700. In a particular embodiment, network channels 782 and 784 are of a different type than peripheral channel 772 and network interface 780 translates information from a format suitable to the peripheral channel to a format suitable to external devices. An example of network channels 782 and 784 includes InfiniBand channels, Fibre Channel channels, Gigabit Ethernet channels, proprietary channel architectures, or a combination thereof. Network channels 782 and 784 can be coupled to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
receiving by an information handling system code to generate a license key for a product;
determining input variables of the code;
mapping the input variables of the code to parameters maintained by an order processing system of the business;
obtaining values of the input variables from the values of the parameters; and
executing the code using the obtained values as input, thereby generating a license key for the product.

2. The method of claim 1 wherein:
the obtaining comprises:
creating a template, wherein variables contained in the template refer to the parameters maintained by the product fulfillment system; and
substituting the values of the parameters for the variables contained in the template; and
the executing comprises executing the code using the substituted values as input.

3. The method of claim 2 wherein:
the executing the code comprises calling the code by a command line command; and
the template describes a format of the command line command, the format including a specification of a placement in the command line of values for the variables contained in the template.

4. The method of claim 3 wherein:
the method further comprises determining that additional input variables for the code refer to data generated during production of the product at a factory; and
the executing the code comprises:
providing to the factory the template, the format of the command line command, and the values for the variables contained in the template; and
calling the code by a command line command at the factory, wherein the command line command includes values for the additional input variables.

5. The method of claim 4 further comprising providing to the product fulfillment system data to enable regeneration of the license key.

6. The method of claim 1 further comprising:
parsing an order, thereby determining that the order contains an order for the product with a first quantity of features; and
generating the license key for the product as part of the order, wherein the generated license key permits a user to use the product with the first quantity of features.

7. The method of claim 6 wherein:
the parsing further comprises determining that the order contains an order for a second product with a second quantity of features; and
the generated license key permits a user to use the product with the first quantity of features and the second product with the second quantity of features.

8. The method of claim 7 wherein:
the method further comprises determining that the order contains an order for a first number of the product with a first quantity of features and an order for a second number of the product with a second quantity of features; and
the generated license key permits the user to use the first number of the first product with the first quantity of features and the second number of the first product with the second quantity of features.

9. The method of claim 1 wherein:
the product is available for sale with a first set of features and is available for sale with a second set of features;
an order of the product entitled a purchaser to the first set of features; and
the generated license key grants the purchaser use of the first set of features.

10. A method comprising:
developing code to generate a license key for a product of a business;
generating a mapping of input variables of the code to parameters maintained by an order processing system of the business;
receiving an order for the product;
generating values of the parameters as a result of processing the order for the product;
providing the values of the parameters as input to the code via the mapping; and
executing the code on the provided values of the parameters, thereby producing a license key for the product.

11. The method of claim 10 wherein the parameters are selected from a group consisting of:
a start date of the license key;
an end date of the license key;
a unique identifier of the product;
a unique identifier of the order for the product;
a number of units of the product included in the order; and
a set of features for the product included in the order.

12. The method of claim 10 wherein the providing and executing comprise calling the code by a command line command, wherein the command line command contains the values of the parameters.

13. The method of claim 12 wherein the providing comprises:
creating a template containing variables, the variables representing the input variables of the code;
referencing the values of the parameters maintained by the order processing system as values for the variables of the template;
substituting the values of the parameters for the variables contained in the template; and
providing the substituted values as input to the code.

14. The method of claim 10 wherein:
the method further comprises determining that the order contains an order for a second product with a second quantity of features; and
the generated license key permits a user to use the product with the first quantity of features and the second product with the second quantity of features.

15. The method of claim 14 wherein:
the method further comprises determining that the order contains an order for a first number of the product with a first quantity of features and an order for a second number of the product with a second quantity of features; and
the generated license key permits the user to use the first number of the first product with the first quantity of features and the second number of the product with the second quantity of features.

16. An information handling system comprising:
a product fulfillment system to process orders for products, the processing including maintaining product data and order data; and
a license generation system to receive product data and order data about orders for products from the product fulfillment system and to generate license keys for the products, wherein the generating comprises executing software programs using as input values received from the product fulfillment system.

17. The information handling system of claim 16 wherein:
the license generation system includes a template database, wherein each template of the template database contains variables representing input variables of a software program of the software programs to generate license keys for a product; and
the executing the software programs using as input values received from the product fulfillment system comprises:
mapping the input variables of the software routines to parameters maintained by the product fulfillment system;
obtaining the values of the parameters; and
executing the software programs using as input the values of the parameters.

18. The information handling system of claim 17 wherein:
the executing the software programs comprise calling the software programs by command line commands; and
each template describes a format of a command line command, the format including a specification of a placement in the command line of values for the variables contained in the template.

19. The information handling system of claim 18 wherein the license generation system is to:
determine that an input value for a software routine of the software routines to generate a license key for a product is generated during production of the product at a factory; and
provide to the factory the template, the format of the command line command, and the values of the parameters for execution of the software routine by the factory.

20. The information handling system of claim 16 wherein:
the product fulfillment system is to determine that an order contains a first suborder for a first number of a product with a first quantity of features and a second suborder for a second number of the product with a second quantity of features; and
the license generation system is to generate a license key, the license key granting a purchaser the use of the first number of the first product and the second number of the second product.
